(19) United States
(12) Patent Application Publication
(10) Pub. No.: US 2014/0236481 A1
(43) Pub. Date: Aug. 21, 2014

(54) ROUTE GUIDANCE APPARATUS AND METHOD

(71) Applicant: Electronics and Telecommunications Research Institute, Daejeon (KR)

(72) Inventors: Jeong Woo LEE, Daejeon (KR); Shin Kyung LEE, Daejeon (KR); Doo Seop YUN, Daejeon (KR); Oh Cheon KWON, Daejeon (KR)

(73) Assignee: Electronics and Telecommunications Research Institute, Daejeon (KR)

(21) Appl. No.: 14/100,726

(22) Filed: Dec. 9, 2013

(30) Foreign Application Priority Data
Feb. 21, 2013 (KR) 10-2013-0018449

(51) Int. Cl. G01C 21/34

(52) U.S. Cl. CPC G01C 21/34
USPC 701/527; 701/537

(57) ABSTRACT

Provided is a route guidance apparatus and method including receiving at least two pieces of route information provided from at least two route providing servers, analyzing the at least two pieces of route information and converting the at least two analyzed pieces of route information to a common data format, classifying the at least two converted pieces of route information into categories of similar routes based on a predetermined similarity level, selecting one of the categories, then selecting, from the selected category, one of the at least two pieces of route information to be a node route for each section node, and interconnecting node routes selected for the respective section nodes, thereby generating an entire route.

### CROSS-REFERENCE TO RELATED APPLICATION

This application claims the priority benefit of Korean Patent Application No. 10-2013-0018449, filed on Feb. 21, 2013, in the Korean Intellectual Property Office, the disclosure of which is incorporated herein by reference.

### BACKGROUND

1. Field of the Invention

The present invention relates to an apparatus and method for providing guidance along a route based on a plurality of guided routes.

2. Description of the Related Art

A navigation device displays a current location of a moving object, for example, a vehicle, on a map provided on a display based on information received by a global positioning system (GPS). Currently, such navigation devices are mounted in various forms of transportation, for example, a ship, an airplane, and an automobile, and are widely used to identify a current location and a speed of the moving object, or determine a route being travelled.

A vehicular navigation device for a vehicle traveling a road provides various pieces of information associated with a road currently being travelled, a current location, a driving route, a degree of road congestion, and the like in visual and auditory manners. In addition, the vehicular navigation device provides various pieces of information needed during a driving time. For example, the vehicular navigation device may display information associated with a direction in which a vehicle travels, a distance from a destination, a current speed, a route set by a driver in advance, an optimized route to a destination, and the like.

The vehicular navigation device receive a radio wave indicating a latitude, a longitude, and an altitude from a plurality of satellites included in a GPS, and determines a current location of a vehicle, thereby displaying map data including the current location. In addition, the vehicular navigation device may receive a satellite wave from a GPS satellite and operate at a wave reception distance from the GPS satellite. Also, the vehicular navigation device detects the current location and the velocity of the vehicle and detects map data with respect to a relative region stored in advance, thereby displaying the detected current location with the map data through a displaying unit.

Currently, in a case of a route guidance system for smart phones, only route guidance provided by a predetermined manufacturer is available to users. Although a currently used product provides inappropriate route guidance, a user would have no choice other than to utilize the inappropriate route guidance provided by a particular manufacturer. Also, a single terminal may provide only one form of route guidance.

Each manufacturer has a different route guidance algorithm suitable for providing guidance along a route in a predetermined situation or a predetermined region. However, route guidance incorporating integrated characteristics of various manufacturers is yet to be provided.

### SUMMARY

An aspect of the present invention provides a route guidance apparatus including a route receiver to receive at least two pieces of route information provided by at least two route providing servers, a data converting unit to analyze the at least two pieces of route information and convert the analyzed at least two pieces of route information to a common data format, a route classifier to classify the at least two converted pieces of route information into categories of similar routes based on a predetermined similarity level, and select one of the categories, a route analyzer to select, from the selected category, one of the at least two pieces of route information to be a node route for each section node, and a route generator to interconnect node routes selected for the respective section node, thereby generating an entire route.

The route classifier and the route analyzer may select the category and the node route based on predetermined setting data.

The setting data may include at least one of route search condition information, user purpose information, user preference information, and route guidance characteristic information of the at least two route providing servers.

The route search condition information may include one of a recommended route, a route via toll-free roads, a route via highways, a route via national roads, a shortest time route, and a shortest distance route.

The user purpose information may include at least one of a fast route, an environmentally-friendly route, and a sightseeing route.

The user preference information may include at least one of a route category provided by a most popular route guidance server, a route category including a majority of users, and a category including a route provided by a predetermined route guidance server.

The route guidance apparatus according to an aspect of the present invention may further include a storage unit to collect the at least two pieces of route information and store the collected at least two pieces of route information.

The route classifier may analyze a route from a departure point to a destination based on information on coordinates associated with the route from the departure point to the destination with respect to each of the at least two pieces of route information.

The route classifier may select one of the categories based on the user preference information.

The route analyzer calculates a weighted value for each of the at least two pieces of route information based on the user purpose information, the user preference information, and the route guidance characteristic information and selects the node route based on the weighted value of each of the at least two pieces of route information.

Another aspect of the present invention also provides a route guidance method including receiving at least two pieces of route information provided from at least two route providing servers, analyzing the at least two pieces of route information and converting the at least two analyzed pieces of route information to a common data format, classifying the at least two converted pieces of route information into categories of similar routes based on a predetermined similarity level, selecting one of the categories, selecting, from the selected category, one of the at least two pieces of route information to be a node route for each section node, and interconnecting node routes selected for the respective section nodes, thereby generating an entire route.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a configuration of a route guidance apparatus according to an embodiment of the present invention;

FIG. 2 is a block diagram illustrating a detailed configuration of a route guidance apparatus according to an aspect of the present invention;

FIG. 3 is a diagram illustrating an example of setting data according to an aspect of the present invention;

FIG. 4 is a diagram illustrating a process of estimating route guidance information; and

FIG. 5 is a flowchart illustrating a route guidance method according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

When it is determined detailed description related to a related known function or configuration they may make the purpose of the present invention unnecessarily ambiguous in describing the present invention, the detailed description will be omitted here. Also, terminologies used herein are defined to appropriately describe the exemplary embodiments of the present invention and thus may be changed depending on a user, the intent of an operator, or a custom. Accordingly, the terminologies must be defined based on the following overall description of this specification.

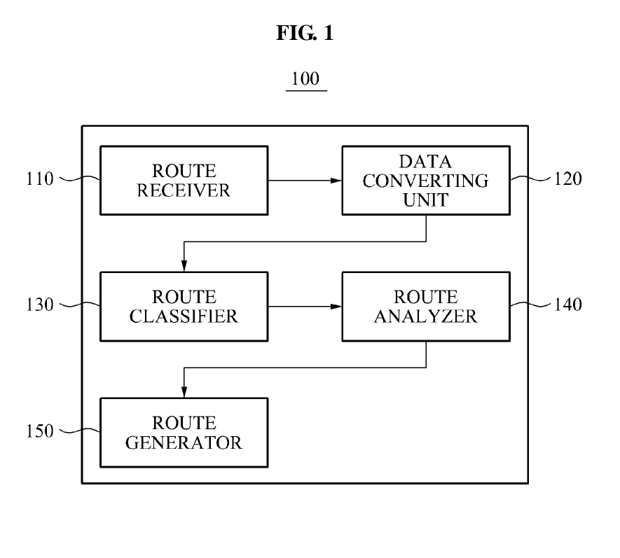

FIG. 1 is a block diagram illustrating a configuration of a route guidance apparatus 100 according to an embodiment of the present invention.

Referring to FIG. 1, the route guidance apparatus 100 according to an embodiment of the present invention includes a route receiver 110, a data converting unit 120, a route classifier 130, a route analyzer 140, and a route generator 150.

The route receiver 110 may receive at least two pieces of information provided by at least two route providing servers. The data converting unit 120 may analyze the at least two pieces of route information and convert the analyzed information to a common data format.

The route classifier 130 may classify the at least two converted pieces of information into categories of similar routes based on a predetermined similarity level, and select one of the categories. The route analyzer 140 may select, from the selected category, one of the at least two pieces of route information to be a node route for each section node. The route generator 150 may interconnect node routes selected for the respective section nodes, thereby generating an entire route.

Each manufacturer may provide route guidance for a predetermined destination using individual guidance algorithm through the route providing server. When a user requests route guidance for a predetermined destination, the route guidance apparatus according to an aspect of the present invention may integrate results of route guidance for the predetermined destination provided by manufacturers and analyze the results of route guidance, thereby converting the analyzed results to common route information.

Based on the converted common route information, the route guidance apparatus may classify the route guidance into categories of similar routes and select an optimized category from among the classified categories. Also, the route guidance apparatus may analyze the route guidance of the selected category again, and generate a route for each section node by incorporating a common portion or a portion having a characteristic of a manufacturer.

The route guidance apparatus 100 may provide a user with a result generated through the foregoing process as new route guidance.

The route classifier 130 and the route analyzer 140 may select the category and the node route based on a predetermined setting data.

The setting data may include various forms of information, for example, route search condition information, user purpose information, user preference information, route guidance characteristic information of the at least two route providing servers, and the like.

The route search condition information may include information corresponding to various search conditions, for example, a recommended route, a route via toll-free roads, a route via highways, a route via national roads, a shortest time route, and a shortest distance route, and the like.

The user purpose information may include various forms of information suitable for use depending on a driving preference of a driver, for example, a fast route, an environmentally-friendly route, a sightseeing route, and the like.

The user preference information may include route guidance information corresponding to various user preferences, for example, a route category provided by the most popular route guidance server, a route category including a majority of users, a category including a route provided by a predetermined route guidance server, and the like.

The route classifier 130 may analyze a route from a departure point to a destination based on information on coordinates associated with the route from the departure point to the destination with respect to each of the at least two pieces of route information.

The route classifier 130 may select one of the categories based on the user preference information.

The route analyzer 140 may calculate a weighted value for each of the at least two pieces of route information based on the user purpose information, the user preference information, and the route guidance characteristic information, and select the node route based on the weighted value for each of the at least two pieces of route information.

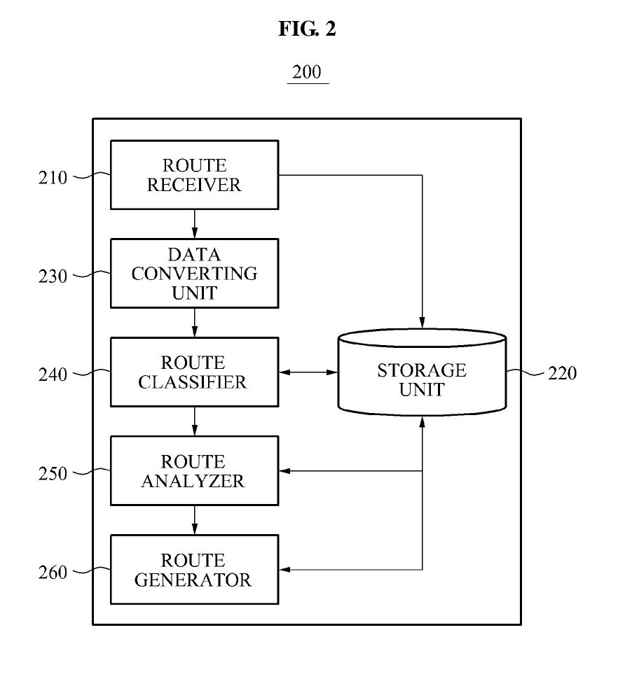

FIG. 2 is a block diagram illustrating a configuration of a route guidance apparatus 200 according to an aspect of the present invention in detail.

Referring to FIG. 2, the route guidance apparatus 200 according to an aspect of the present invention includes a route receiver 210 receiving at least two pieces of route information provided from at least two route providing servers, a storage unit 220 collecting the at least two pieces of route information and storing the collected at least two pieces of route information, a data converting unit 230 analyzing the at least two pieces of route information and converting the analyzed at least two pieces of route information to a common data format, a route classifier 240 classifying the at least two converted pieces of route information into categories of similar routes based on a predetermined similarity level and select one of the categories, a route analyzer 250 selecting, from the selected category, one of the at least two pieces of route information to be a node route for each section node, and a route generator 260 interconnecting node routes selected for the respective section nodes, thereby generating an entire route.

The route guidance apparatus 200 may provide a user with new route guidance by integrating route guidance provided by manufacturers and analyzing a result of the integrating.

The route guidance apparatus 200 may receive the route guidance provided through the route providing server of each manufacturer. The received route information may be converted to a common data format so as to be analyzed and utilized.

The converted route guidance may be classified into categories of similar routes and a single category may be selected from among the categories. The route guidance apparatus 200 may determine a route to be selected from among various routes for each of the section nodes included in the selected category and interconnect routes selected for the respective section nodes, thereby generating an entire route.

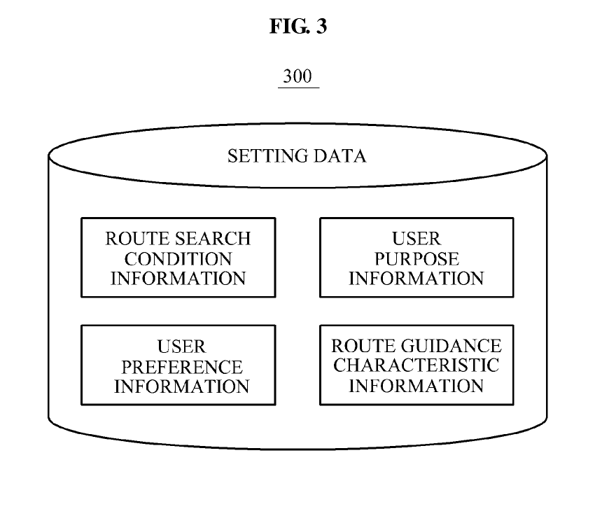

FIG. 3 is a diagram illustrating an example of setting data 300 according to an aspect of the present invention.

Referring to FIG. 3, the setting data 300 includes route search condition information, user purpose information, user preference information, and route guidance characteristic information of a manufacturer. Also, the setting data 300 may be set in advance through a user input.

The route search condition information may include information corresponding to various search conditions, for example, a recommended route, a route via toll-free roads, a route via highways, a route via national roads, a shortest time route, and a shortest distance route, and the like. The user purpose information may include various forms of information suitable for use in a driving preference of a driver, for example, a fast route, an environmentally-friendly route, a sightseeing route, and the like.

The user preference information may include route guidance information corresponding to various user preferences, for example, a route category provided by the most popular route guidance server, a route category including a majority of users, a category including a route provided by a predetermined route guidance server, and the like. The route guidance characteristic information may include characteristic information associated with suitable route guidance for a complicated region, route guidance suitable for a predetermined region, for example, cites such as Incheon, Busan, and the like, route guidance suitable for applying real time traffic information in a predetermined time period, and the like.

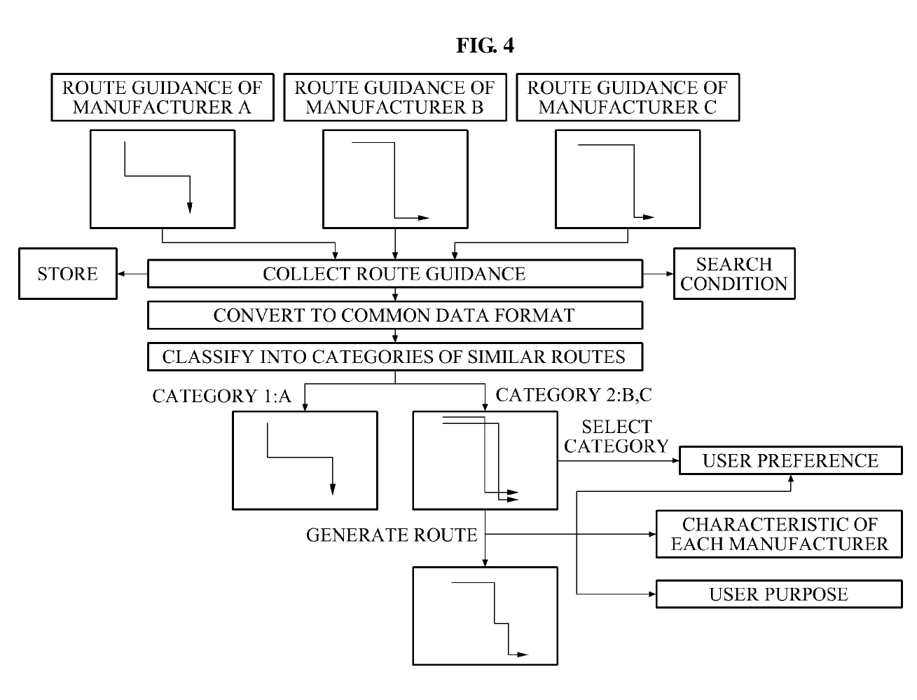

FIG. 4 is a diagram illustrating a process of estimating route guidance information.

Referring to FIG. 4, when a user requests route guidance for a predetermined destination, a route guidance apparatus may collect results of route guidance for the predetermined destination provided by manufacturers.

The route guidance apparatus may collect all route guidance information provided by manufacturers based on search conditions, and store the collected route guidance in a system storage unit for representing a quick result in response to a subsequent search. For example, the route guidance apparatus may store, as the search conditions, information on a recommended route, a route via toll-free roads, a route via highways, a route via national roads, a shortest time route, a shortest distance route, and the like.

The collected route guidance may be converted to a common data format so as to be analyzed and utilized. The converted route guidance may be classified into categories of similar routes.

The route guidance may be analyzed based on a route from a departure point to a destination based on information on coordinates associated with the route from the departure point to the destination, and classified into categories of similar routes. Here, each of the categories may include routes included in a predetermined range from the departure point to the destination. Also, route classification may be performed by categorizing groups based on a similarity using a clustering scheme, and the like.

The route guidance apparatus may once again determine a route to be selected from among the categories classified by the similar route based on user preference information included in the setting data. For example, the route guidance apparatus may determine, based on a user preference, a setting with respect to a route category provided by the most popular route guidance server, route category including a majority of users, a category including a route provided by a predetermined route guidance server, and the like.

The user preference information may be fed back for determining a route of a popular manufacturer. The route guidance apparatus may select the category based on the setting data and divide the route from the departure point to the destination into the section nodes, thereby analyzing the divided route.

The route guidance apparatus may determine a route for each section node based on a characteristic of route guidance provided by each manufacturer, user preference, user purpose, an estimated time for a section node, and the like, that may be included in the setting data. The route guidance apparatus may determine, based on the user purpose, a setting, for example, a driving via fast route, a driving via environmentally-friendly route, a driving via sightseeing route, and the like.

The route guidance apparatus may calculate a weighted value with respect to the characteristic of route guidance provided by each manufacturer, the user preference, and the user purpose to establish scores to be applied to the manufacturer provided route guidance. For example, the route guidance apparatus may calculate, with respect to a single section node, an estimated time of each manufacturer provided route included in the section node, apply the weighted value to a manufacturer provided route selected based on the user preference. When the user purpose corresponds to the driving via a sightseeing route, the route guidance apparatus may apply the weighted value to a manufacturer provided route including a large amount of travel information, and apply the weighted value to a manufacturer provided route applying real time information of a current section node or regional characteristics of the current section node.

The route guidance apparatus may calculate a sum of the weighted value and the scores for each manufacturer provided route, thereby selecting a section node having a highest score. Processes of applying the weighted value and calculating the scores may be performed in various manners based on characteristics of a system.

The route guidance apparatus may generate the selected section nodes to be an item of route guidance information, and the generated route guidance information may be transmitted to a user terminal and used for route guidance.

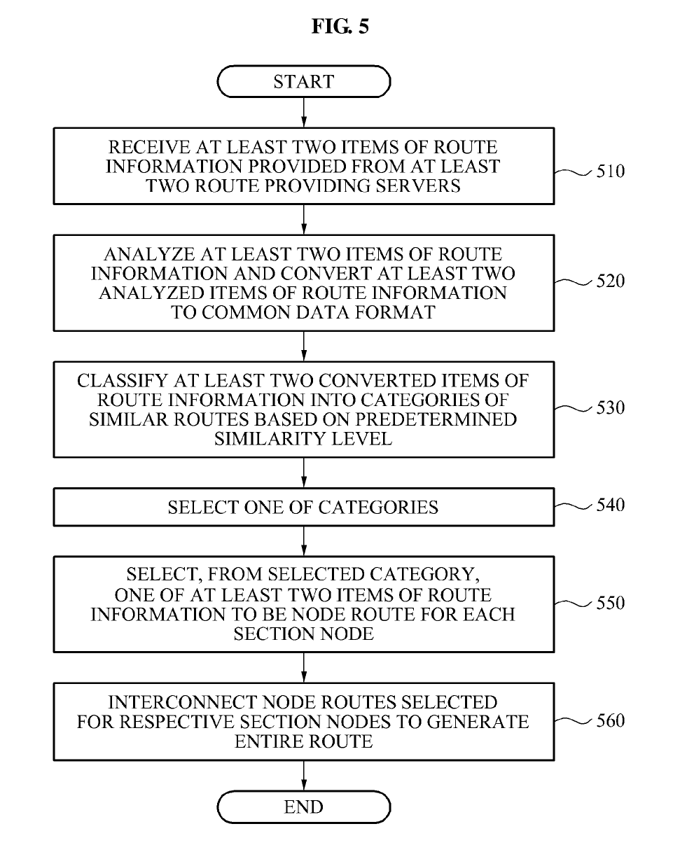

FIG. 5 is a flowchart illustrating a route guidance method according to an embodiment of the present invention.

Referring to FIG. 5, in operation 510, a route guidance apparatus may receive at least two pieces of route information provided from at least two route providing servers. In operation 520, the route guidance apparatus may analyze the at least two pieces of route information and convert the at least two analyzed pieces of route information to a common data format.

In operation 530, the route guidance apparatus may classify the at least two converted pieces of route information into categories of similar routes based on a predetermined similarity level. In operation 540, the route guidance apparatus may select one of the categories.

In operation 550, the route guidance apparatus may select one of the at least two pieces of route information to be a node route for each section node, from the selected category. In operation 560, the route guidance apparatus may interconnect node routes selected for the respective section nodes, thereby generating an entire route.

According to an aspect of the present invention, it is possible to provide a result derived by fully integrating route guidance provided by various manufacturers in lieu of route guidance provided by a predetermined manufacturer.

According to aspect of the present invention, it is possible to use route guidance provided in a common data format and adopting each strong point of manufacturers for optimizing route guidance, thereby providing a user with satisfactory route guidance irrespective of a kind of manufacturer.

The above-described exemplary embodiments of the present invention may be recorded in non-transitory computer-readable media including program instructions to implement various operations embodied by a computer. The media may also include, alone or in combination with the program instructions, data files, data structures, and the like. to Examples of non-transitory computer-readable media include magnetic media such as hard disks, floppy disks, and magnetic tape; optical media such as CD ROM discs and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A route guidance apparatus, comprising:
a route receiver to receive at least two pieces of route information provided by at least two route providing servers;
a data converting unit to analyze the at least two pieces of route information and convert the analyzed at least two pieces of route information to a common data format;
a route classifier to classify the at least two converted pieces of route information into categories of similar routes based on a predetermined similarity level, and select one of the categories;
a route analyzer to select, from the selected category, one of the at least two pieces of route information to be a node route for each section node; and
a route generator to interconnect node routes selected for the respective section node, thereby generating an entire route.

2. The apparatus of claim 1, wherein the route classifier and the route analyzer select the category and the node route based on predetermined setting data.

3. The apparatus of claim 2, wherein the setting data comprises at least one of route search condition information, user purpose information, user preference information, and route guidance characteristic information of the at least two route providing servers.

4. The apparatus of claim 3, wherein the route search condition information comprises one of a recommended route, a route via toll-free roads, a route via highways, a route via national roads, a shortest time route, and a shortest distance route.

5. The apparatus of claim 3, wherein the user purpose information comprises at least one of a fast route, an environmentally-friendly route, and a sightseeing route.

6. The apparatus of claim 3, wherein the user preference information comprises at least one of a route category provided by a most popular route guidance server, a route category including a majority of users, and a category including a route provided by a predetermined route guidance server.

7. The apparatus of claim 1, further comprising:
a storage unit to collect the at least two pieces of route information and store the collected at least two pieces of route information.

8. The apparatus of claim 1, wherein the route classifier analyzes a route from a departure point to a destination based on information on coordinates associated with the route from the departure point to the destination with respect to each of the at least two pieces of route information.

9. The apparatus of claim 3, wherein the route classifier selects one of the categories based on the user preference information.

10. The apparatus of claim 3, wherein the route analyzer calculates a weighted value for each of the at least two pieces of route information based on the user purpose information, the user preference information, and the route guidance characteristic information and selects the node route based on the weighted value of each of the at least two pieces of route information.

11. A route guidance method, comprising:
receiving at least two pieces of route information provided from at least two route providing servers;
analyzing the at least two pieces of route information and converting the at least two analyzed pieces of route information to a common data format;
classifying the at least two converted pieces of route information into categories of similar routes based on a predetermined similarity level;
selecting one of the categories;
selecting, from the selected category, one of the at least two pieces of route information to be a node route for each section node; and
interconnecting node routes selected for the respective section nodes, thereby generating an entire route.

12. The method of claim 11, wherein the selecting of one of the categories comprises selecting one of the categories based on a predetermined setting data, and the selecting of one of the at least two pieces of route information comprises selecting one of the at least two pieces of route information to be the node route based on the predetermined setting data.

13. The method of claim 12, wherein the predetermined setting data comprises at least one of route search condition information, user purpose information, user preference information, and route guidance characteristic information of the at least two route providing servers.

14. The method of claim 13, wherein the route search condition information comprises one of a recommended route, a route via toll-free roads, a route via highways, a route via national roads, a shortest time route, and a shortest distance route.

15. The method of claim 13, wherein the user purpose information comprises at least one of a fast route, an environmentally-friendly route, and a sightseeing route.

16. The method of claim 13, wherein the user preference information comprises at least one of a route category provided by a most popular route guidance server, a route category including a majority of users, and a category including a route provided by a predetermined route guidance server.

17. The method of claim 11, further comprising:
collecting the at least two pieces of route information and storing the at least two collected pieces of route information.

18. The method of claim 11, wherein the classifying comprises analyzing a route from a departure point to a destination based on information on coordinates associated with the route from the departure point to the destination with respect to each of the at least two pieces of route information.

19. The method of claim 13, wherein the selecting of one of the categories comprises selecting one of the categories based on the user preference information.

20. The method of claim 13, wherein the selecting of one of the at least two pieces of route information comprises calculating a weighted value for each of the at least two pieces of route information based on the user purpose information, the user preference information, and the route guidance characteristic information and selecting the node route based on the weighted value for each of the at least two pieces of route information.
